(19) United States
(12) Patent Application Publication
(10) Pub. No.: US 2014/0248089 A1
(43) Pub. Date: Sep. 4, 2014

(54) Wire Rope Payout Upon Tensile Demand

(71) Applicant: Earth Tool Company LLC, Oconomowoc, WI (US)

(72) Inventors: Walter G. Thompson, Janesville, WI (US); Kelvin C. Aus, Watertown, WI (US); Theodore P. Schloer, Grafton, WI (US)

(73) Assignee: Earth Tool Company LLC, Oconomowoc, WI (US)

(21) Appl. No.: 14/196,510

(22) Filed: Mar. 4, 2014

Related U.S. Application Data
(60) Provisional application No. 61/772,378, filed on Mar. 4, 2013.

(51) Int. Cl. B66D 1/48; B66D 1/36; B66D 1/26; F16L 1/06

(52) U.S. Cl. CPC B66D 1/48; F16L 1/06; B66D 1/36; B66D 1/26
USPC 405/184.3; 254/334; 254/283; 254/270

(57) ABSTRACT

A control system for a capstan assembly for use with a winch during wire rope payout. The control system comprises a sensor that detects the rope when it is in a predetermined position indicative of tension placed on the rope by an operator. The control system further comprises an actuator for rotating the capstans such that the wire rope is paid out from the winch when the actuator is in a first position. The control system causes the capstans to rotate and the wire rope to pay out when the rope is in the predetermined position and the actuator is in the first position. The control system ceases rotation when the actuator is removed from the first position or the rope is no longer in the predetermined location.

### CROSS REFERENCE TO RELATED APPLICATION

This application claims the benefit of provisional patent application Ser. No. 61/772,378, filed on Mar. 4, 2013, the entire contents of which are incorporated herein by reference.

### FIELD

The present invention relates generally to a winch system for wire rope takeout to be used in conjunction with a pipe bursting application, underground utility work and overhead line installation.

### BACKGROUND

Dual capstan winches are commonly used in underground construction and for overhead power line pulling. The work of pulling electrical conductors through buried conduits, pulling electrical conductors between poles or pulling and guiding pneumatic pipe bursting equipment through existing pipes is a typical application for these winches. Additional details on dual capstan winches may be found in U.S. Pat. No. 7,048,257, the contents of which are incorporated herein by reference.

During use of such a winch, the rope, most often wire rope, must be stripped from a storage drum used to feed the capstans. The capstans pull the rope from the drum feeding it through the circuitous route of the capstan grooves and paying it out of the winch to the work area. It is often a significant portion of the project to payout the rope off the storage drum, through the capstans and through the buried pipe or between poles.

The aspect of a dual capstan winch that is unique has to do with payout, the removal or stripping of rope from the storage drum. Typically, an operator stands facing a dual capstan winch with a short length of the tail end of the rope between his gloved hand and the machine. Both capstans are turning, the wire lays within all the proper grooves of the capstans, yet no wire is being stripped from the storage drum and no wire is paid from the winch allowing the operator to back away from the winch. The operator begins to walk backwards putting slight tension on the tail end of the rope emanating from the winches capstans, rope is fed out at precisely the velocity the operator is walking. The operator walks back 10 steps and stops, the wire rope stops feeding out the moment he stops and tension is relieved from the rope. During this entire example, the capstans are turning at a speed that would permit the operator to walk quickly, yet he walked slowly. The operator begins walking extremely slowly and the rope is stripped from the storage drum and fed to the operator at the velocity which causes tension to be applied to it.

With the winch only providing additional rope as ‘requested’ by tension on the rope's tail, the winch is often left running full speed with the engine at high RPM's while the job is stopped due to conditions or circumstances not related to the winch. Further, because the winch may be at great distance, even thousands of feet away from the operators, the inclination to idle the winch down or turn it off all together during these slack periods is low. For that reason the present invention allows the winch to idle the engine and stop the capstan rotation after a period of time without tension on the rope tail.

### SUMMARY

The present invention is directed to a winch system for wire rope takeout to be used in conjunction with a pipe bursting application. The invention is directed to an apparatus and method for stopping operation of a winch system comprising a capstan assembly and a sensor. The method comprises winding a rope about the capstan assembly, providing an actuator operable between a first position and a second position, detecting a position of the rope with the sensor, generating a sensor signal when the rope is at a predetermined position indicative of tension being placed on the rope by an operator, and rotating the capstan assembly in response to the sensor signal when the actuator is in the first position.

The apparatus of the present invention comprises a capstan assembly, a sheave, a tension sensor, and a controller. The capstan assembly comprises two capstans each having a friction groove to engage the wire rope. The capstan assembly is operable in a rotating and non-rotating setting. The tension sensor is disposed between the capstan assembly and the sheave for detecting a position of the rope and generating a sensor signal when the rope is in a predetermined position. The controller receives the sensor signal and places the capstan assembly in the rotating setting when the sensor signal is received and places the capstan assembly in the non-rotating setting when the sensor signal is not received.

### BRIEF DESCRIPTION OF THE DRAWINGS

FIG. 1 is a perspective view of an enclosed winch system.

FIG. 2 is a perspective view of the winch system of FIG. 1 with its external panel removed.

FIG. 3 is a perspective view of a capstan assembly for use with the winch system of FIG. 1.

FIG. 4 is a perspective view of a control panel.

FIG. 5 is a diagrammatic representation of the capstan assembly with a tensioned wire rope.

FIG. 6 is a diagrammatic representation of the capstan assembly with an untensioned wire rope.

FIG. 7 is a side view of an alternative tension sensor in the untensioned position.

FIG. 8 is a side view of the alternative tension sensor in FIG. 7 in the tensioned position.

### DESCRIPTION

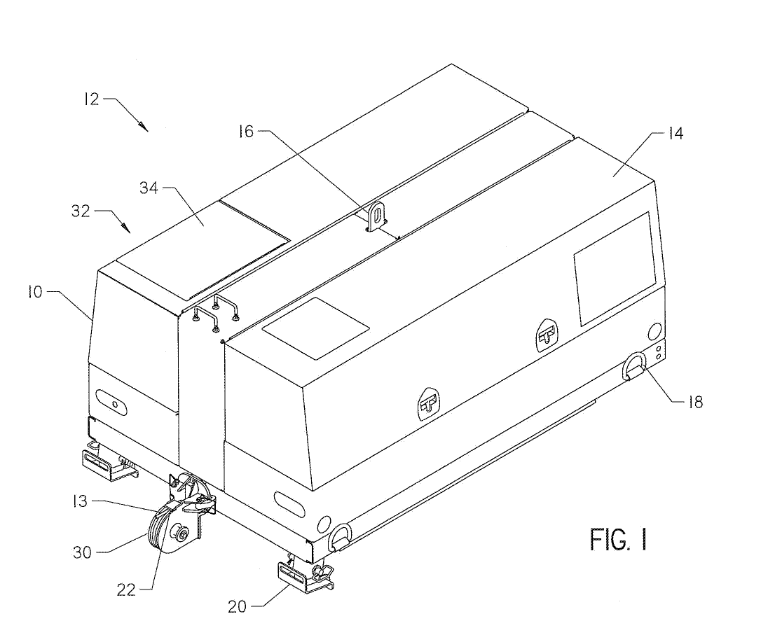

With reference now to the Figures in general and FIG. 1 in particular, shown therein is a frame 10 containing a winch system 12 for winding and unwinding a rope 13. The rope 13 may comprise a wire rope, an insulated wire rope, or other similar wire rope or cable. The frame 10 comprises an external cover 14, a lift eye 16, eye-rings 18, jacks 20, and a rope exit point 22. The external cover 14 shields inner components of the winch system 12 but can be removed. The lift eye 16 provides a point at which the frame 10 can be lifted and moved. The eye-rings 18 provide a location for the frame 10 to be tied town to a surface, such as a flat-bed or work site. The jacks 20 may be extended and retracted to brace the winch system 12 during operation. Alternatively, a wheel and axle assembly (not shown) may be provided such that the frame 10 may be pulled behind a vehicle. The rope exit point 22 is an aperture formed in the external cover 14 for the rope 13 to exit the winch system 12.

The winch system 12 comprises an external sheave 30 and a control panel 32. The external sheave 30 is adapted to support and direct the rope 13 of the winch system 12. As shown, the external sheave 30 is located proximate the rope exit point 22. The sheave 30 may pivot relative to the frame 10. The control panel 32 controls operations of the winch system 12. As shown, the control panel 32 is covered by a panel door 34. As shown, the control panel 32 is integral with the frame 10. One skilled in the art will appreciate that the control panel 32 may be located remotely from the frame, such as on a remote control, a separate control panel or a mobile device.

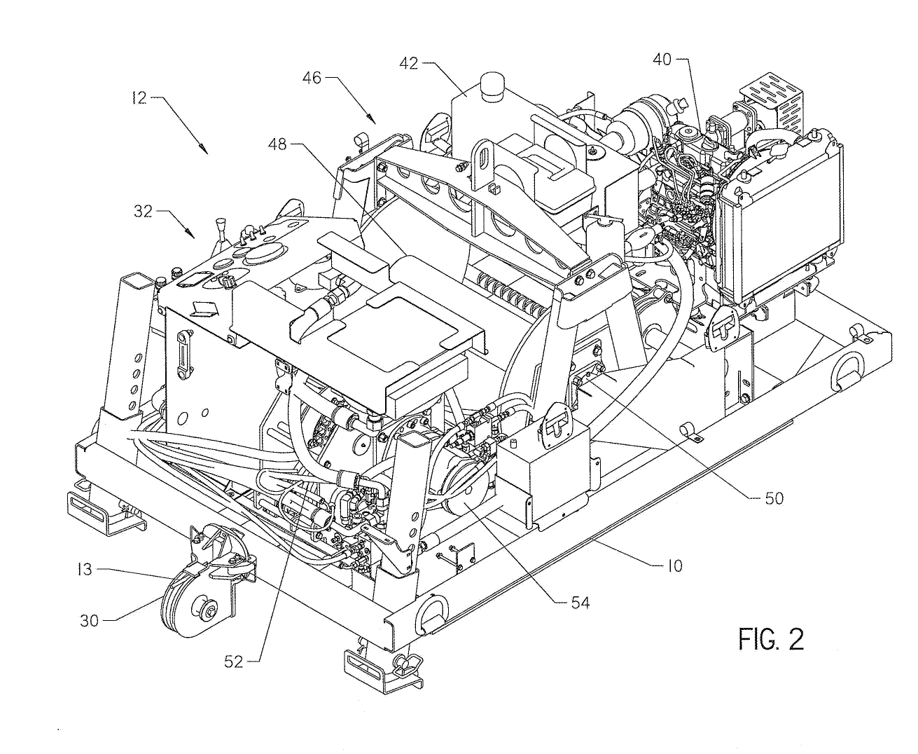

With reference now to FIG. 2, the frame 10 is shown with the external cover 14 (FIG. 1) removed. The winch system 10 further comprises an engine 40, a fuel tank 42, a reel 46 comprising a rotating drum 48, a reel motor 50, a capstan assembly 52, and a capstan motor 54. The engine 40 provides power to the capstan motor 54 and reel motor 50, as well as any other hydraulically powered components of the winch system 12. The engine 40 is fueled by fuel from fuel tank 42. The fuel in the fuel tank 42 may be diesel or any other fuel suitable to power an engine to actuate a pump to produce sufficient pressurized hydraulic fluid for powering hydraulic components. Alternatively, one of ordinary skill could anticipate that the winch system 12 could be electrically powered with a fuel cell replacing the engine and electric motors.

The reel 46 is rotated by the reel motor 50. Rotation of the reel 46 causes the rope 13 (FIG. 1) to be stored on the drum 48, or fed from the drum to the capstan assembly 52, depending on the rotation direction of the reel 46. The capstan assembly 52 provides force to the rope 13 taking rope out of the wench 12 or pulling it back during pipe bursting operations. The capstan assembly 52 as shown comprises two capstans that are rotated by the capstan motor 54 The control panel 34 controls operation of the engine 40 and operation, rate and direction of the reel motor 50 and capstan motor 54.

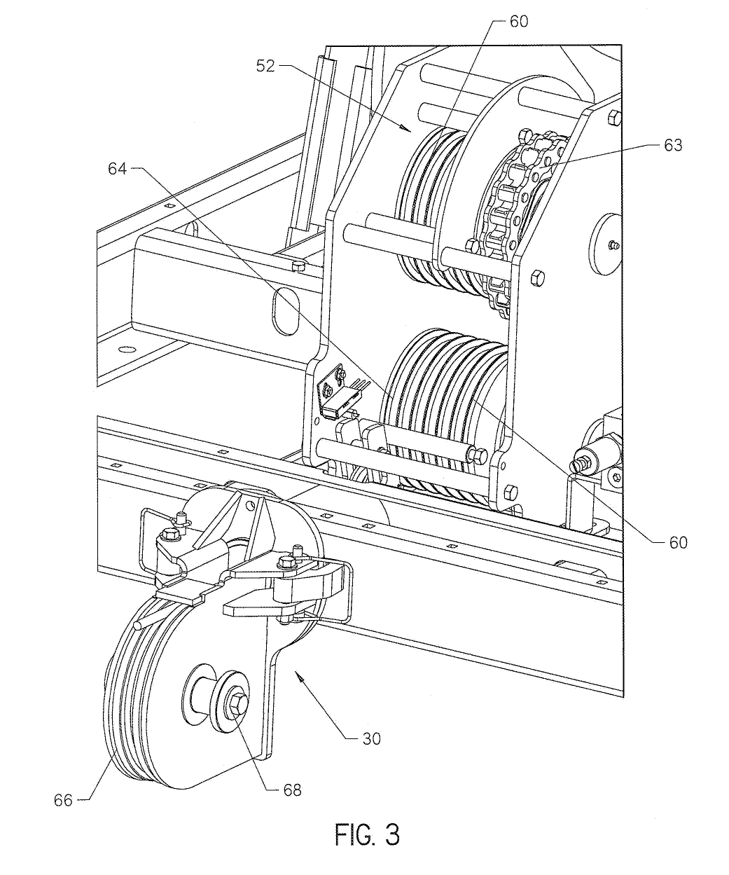

With reference now to FIG. 3, the capstan assembly 52 is shown in more detail with the rope 13 removed for clarity. The capstan assembly 52 comprises a first capstan 60, a second capstan 62 and a drive chain 63. As shown, the first capstan 60 is above the second capstan 62, though the capstans 60, 62 are not required to be vertically disposed. Both capstans 60, 62 comprise deep grooves 64 into which the rope 13 (FIGS. 1-2) lays. The rope 13 may be wound around capstans 60, 62 multiple times and is guided and pushed by the grooves 64 as the capstans rotate. Preferably, the rope 13 is wound around capstans 60, 62 a minimum of eight times. When the rope 13 is tensioned about the capstans 60, 62, the capstans provide frictional force to the rope to enable it to be paid out or reeled in by the winch 12. The drive chain 63 turns the capstans 60, 62 due to operation of the capstan motor 54 (FIG. 2). The external sheave 30 comprises a wheel 66 and a center axle 68. The wheel 66 further guides the rope 13 through the sheave and rotates about the center axle 68. As shown, the wheel 66 has two grooves for supporting one revolution of the rope 13 about the wheel 66.

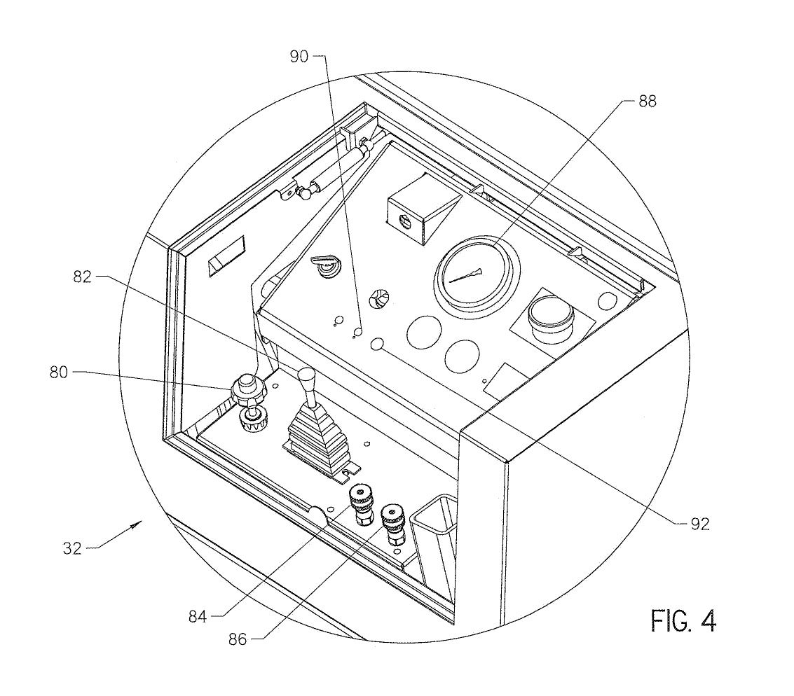

With reference row to FIG. 4, the control panel 32 is shown in more detail. The control panel 32 comprises an engine throttle 80, a rope control actuator 82, an adjustable flow valve 84, a pressure control valve 86, a pressure gauge 88, a capstan adjustment switch 90, and a capstan motor pressure switch 92. The engine throttle 80 controls the power supplied to the winch system 12 by the engine 40 (FIG. 2). The rope control actuator 82 toggles between a first position and a second position. The rope control actuator 82 could be a joystick, as shown in FIG. 4, but a switch, toggle, or remote control could provide a suitable actuator as well. The rope 13 (FIG. 1) is reeled out when the actuator 82 is in the first position and the rope is reeled in when the joystick is in the second position. The flow valve 84 controls rotation speed of the dual capstans 52, and therefore the speed of reeling the rope 13 out or in The pressure control valve 86 sets the maximum capstan motor 54 (FIG. 2) pressure and therefore rope tension. The capstan motor pressure is monitored at the pressure gauge 88.

The capstan adjustment switch 90 allows a “course” or “Hi/Lo” speed adjustment for rotation of the capstans 60, 62. Capstan motor pressure switch 92 temporarily removes the capstan motor 54 from hydraulic power such that capstan motor pressure may be adjusted. One skilled in the art will appreciate that while the control panel 32 is shown integral with the frame 10 in FIG. 4, it could be provided on a separate structure or remote control, such as a mobile phone application or dedicated radio-control device.

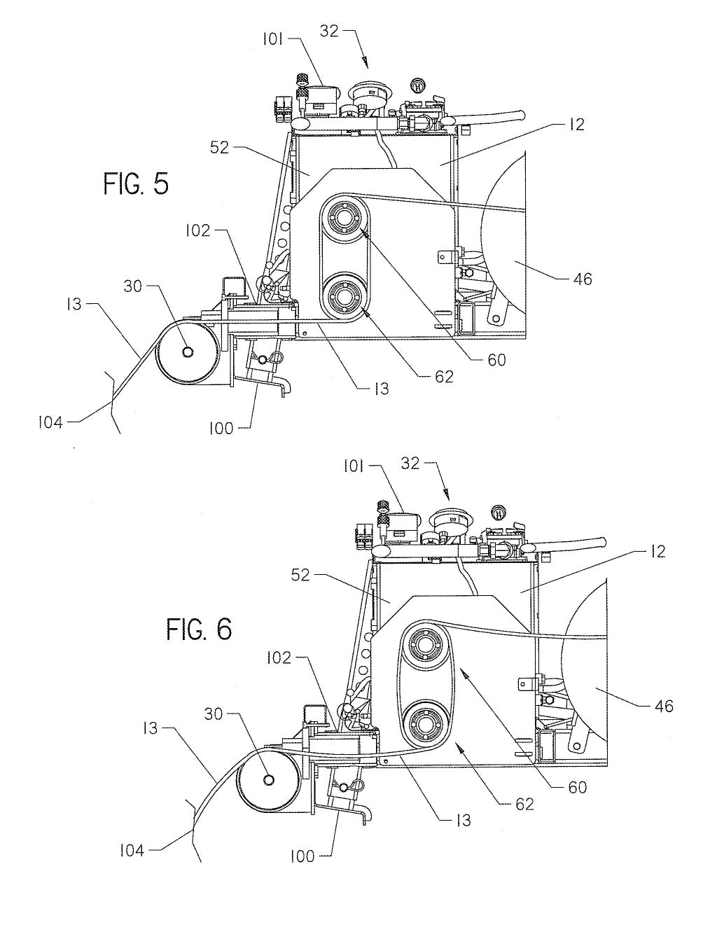

With reference now to FIG. 5, a side view of the winch system 12 is shown. The system further comprises a tension sensor 100 and a controller 101. As shown in FIG. 5, the tension sensor 100 comprises a proximity sensor 102. The proximity sensor 102 may comprise a magnetic sensor, an optical sensor, or any other sensor known in the art. In any case, the proximity sensor 102 detects whether the rope 13 is in a predetermined position indicative of tension being placed on the rope 13. In FIG. 5, the rope 13 is shown travelling from the reel 46, around the capstans 60, 62, through the external sheave 30. The rope 13 is shown without slack, indicative of an operator (not shown) maintaining tension on a tail end 104 of the rope 13. In such a configuration, the proximity sensor 102 senses that the rope 13 is near the predetermined location and the sensor provides a signal to the controller 101. The controller 101 receives the signal indicating that the rope 13 is near the proximity sensor 104 and therefore, an operator is tensioning the rope. Thus, the controller 101 allows the capstan motor 54 to continue operating.

With reference now to FIG. 6, the view of FIG. 5 is shown with an untensioned rope 13. When tension is not provided to the tail end 104 of the rope 13, the rope sags out of the predetermined position. Thus, proximity sensor 102 will not detect the rope 13 at its predetermined position, and will send a signal to the controller 101. The controller 101 receives a signal indicating that the rope is not near the proximity sensor and therefore, an operator is not tensioning the rope. Thus, the controller 101 stops operation of the capstan motor 54 (FIG. 2) and the capstans 60, 62 stop rotating. With added tension, the rope 13 will again be proximate the proximity sensor 102 and the capstans 60, 62 will resume operation as set at the control panel 32 (FIG. 4).

One of ordinary skill will appreciate that wire rope 13 does not instantaneously lose tension due to its tensile load. Thus, the proximity sensor 102 does not immediately send a signal to the controller upon removal of tension from the rope 13. It is only when the lack of tension causes the rope 13 to be removed from the predetermined position that the controller shuts off the capstan assembly 52.

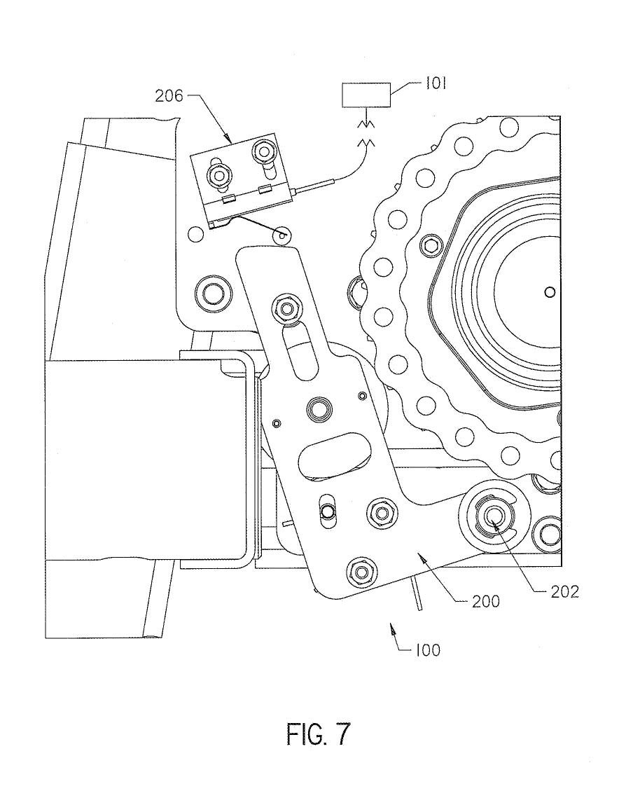

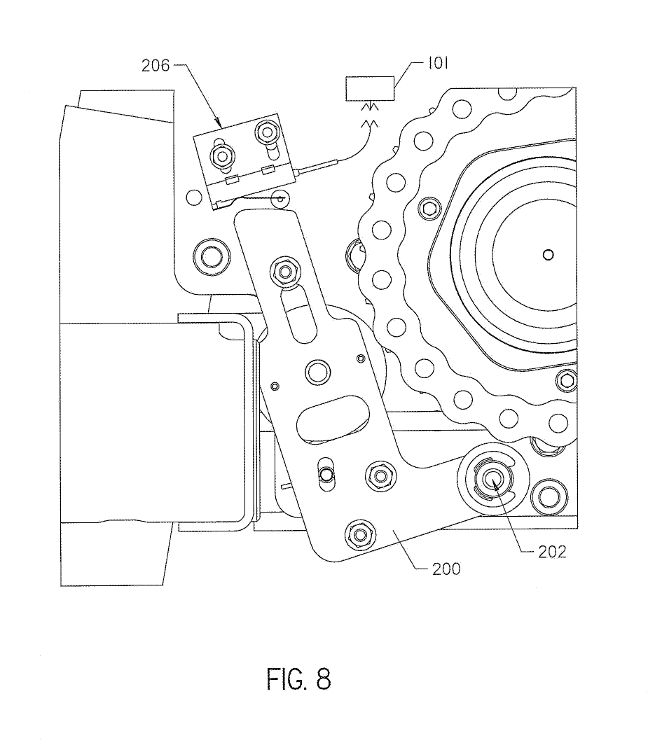

With reference now to FIG. 7 an alternative embodiment of the tension sensor 100 is shown. As shown, the tension sensor 100 comprises an arm 200, a pivot shaft 202, and a microswitch 206. As shown, the angular orientation of the arm 200 is determined by the tension provided by the rope 13 (FIG. 1). The arm 200 rotates about the pivot shaft 202. The angular orientation of the arm 200 is determined by tension in the rope 13. When no tension is applied to the rope 13, the microswitch is in the off position as shown in FIG. 8. The microswitch 206 then sends a signal to the controller 101 indicating that the arm 200 is in a position indicating slack. Thus, the controller 101 stops rotation of the capstan motor 54.

Likewise, FIG. 8 shows the aim 200 in a position indicating that tension is being applied to the rope 13 (FIG. 1). The microswitch is in the on position in FIG. 9. The microswitch 206 then sends a signal to the controller 101 indicating that the arm is in a predetermined location. Thus, the controller 101 allows the capstan motor to continue operating.

In operation, the controller 101 determines whether rope 13 payout should be activated. When an operator is applying tension to the tail end 104 of the rope 13, the tension sensor 100 indicates that the rope is in its predetermined position and sends a sensor signal to the controller 101. If the tension sensor 100 does not indicate that the rope 13 is in the predetermined position, the engine 40 is reduced to idle speed and capstan assembly 52 rotation is stopped. If tension is detected on the rope 13, the controller 101 checks to see if the joystick 82 is in the first position. If so, the engine 40 is set to high speed and the capstan assembly 52 is rotated as dictated by the flow valve 84. Rotation continues until either the joystick is taken out of the first position or tension is no longer detected.

In this manner, the tail end 104 of the rope 13 is removed from the reel 46 and, for example, fed through a pipe (not shown). Once the rope 13 is fed through the pipe, it may be attached to any commercially known and available pipe bursting technology, and pulled back through the pipe for pipe bursting and replacement operations.

One skilled in the art could envision numerous alternative sensors for tension detection of a wire rope, control configurations, and winch configurations. For example, where joysticks are disclosed herein, other actuators would provide similar functionality without changing the scope of the present invention. These design choices are not meant to be limiting on this invention. The winch system 12 may be used to run other lengths of rope, such as overhead utility lines, underground cables for burying in open trenches, wire for fences, etc. Further, alternative controller logic is considered, such as capstan rotation upon joystick actuation or tension detection, rather than joystick actuation and tension detection.

What is claimed is:

1. A winch for pulling a wire rope, the winch comprising:
a capstan assembly comprising a friction groove to engage the wire rope wherein the capstan assembly is operable in a rotating and non-rotating setting;
a sheave for supporting the wire rope;
a tension sensor disposed between the capstan assembly and the sheave for detecting a position of the wire rope and generating a sensor signal when the sensor the wire rope is in a predetermined position; and
a controller for receiving the sensor signal and placing the capstan assembly in the rotating setting when the sensor signal is received and placing the capstan assembly in the non-rotating setting when the sensor signal is not received.

2. The winch of claim 1 wherein the tension sensor comprises a proximity sensor.

3. The winch of claim 1 wherein the tension sensor comprises a mechanical switch.

4. The winch of claim 1 wherein the capstan assembly comprises two capstans.

5. The winch of claim 4 wherein the two capstans are vertically disposed.

6. The winch of claim 5 wherein the rotatable capstans are operable in a first rotating direction and a second rotating direction.

7. The winch of claim 6 wherein the tension sensor comprises a proximity sensor.

8. The winch of claim 1 further comprising:
a joystick for sending a joystick signal to the controller;
wherein the controller places the capstan assembly in the rotating setting when the controller receives the joystick signal and the sensor signal.

9. The winch of claim 8 wherein the controller places the capstan assembly in the non-rotating setting when the controller does not receive one of the joystick signal and the sensor signal.

10. The winch of claim 1 wherein a rate of rotation of the rotating capstans is adjustable.

11. The winch of claim 1 wherein the predetermined location is on a straight line between the capstan assembly and the sheave.

12. A method for unwinding a reel of rope comprising:
winding the rope about a capstan assembly;
placing the rope through a sheave;
rotating the capstan assembly in a first direction;
detecting a position in the rope between the capstan assembly and the sheave;
generating a sensor signal when the rope is at a predetermined position; and
stopping rotation of the capstan assembly in response to cessation of the sensor signal.

13. The method of claim 12 further comprising:
manipulating an actuator to generate a actuator signal;
detecting the actuator signal; and
rotating the capstan assembly in response to the joystick signal.

14. The method of claim 13 further comprising:
pulling the rope into a pipe segment;
connecting the rope to a pipe burster having a greater effective diameter than the pipe segment when a tail end of the rope is through the pipe segment; and
pulling the rope back through the pipe segment by rotating the capstan assembly in a second direction.

15. The method of claim 12 wherein the tension signal comprises a proximity sensor.

16. The method of claim 12 wherein the capstan assembly comprises two vertically disposed capstans.

17. The method of claim 12 wherein the predetermined position is on a straight line between the capstan assembly and the sheave.

18. A method for stopping operation of a winch system comprising a capstan assembly and a sensor, the method comprising:
winding a rope about the capstan assembly;
providing an actuator operable between a first position and a second position;
detecting a position of the rope with the sensor;
generating a sensor signal when the rope is at a predetermined position indicative of tension being placed on the rope by an operator; and
rotating the capstan assembly in response to the sensor signal when the actuator is in the first position.

19. The method of claim 18 further comprising:
ceasing rotation of the capstan assembly when the signal is not generated.

20. The method of claim 18 further comprising:
ceasing rotation of the capstan assembly when the actuator is in the first position.
